(19) United States
(12) Patent Application Publication
(10) Pub. No.: US 2020/0144756 A1
(43) Pub. Date: May 7, 2020

(54) CONNECTOR

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Takaaki HAMAGUCHI, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 16/495,947

(22) PCT Filed: Mar. 16, 2018
(86) PCT No.: PCT/JP2018/010414

§ 371 Date: Sep. 20, 2019

(30) Foreign Application Priority Data
Mar. 29, 2017 (JP) 2017-065451

(51) Int. Cl. H01R 13/50; H01R 43/18

(52) U.S. Cl. CPC H01R 13/50; H01R 43/18

(57) ABSTRACT

Provided is a connector (1) with which it is unlikely that a molding defect will occur during injection molding, and with which it is possible to retain the shape of a housing. The connector (1) has a housing (10) that is formed of a cured product of a thermosetting liquid silicone. The cured product has a Vickers hardness of 650 or greater. The housing (10) has a plurality of terminal receiving chambers (101) for receiving terminals that are connected to end portions of wires, partition walls (102) between adjacent ones of the terminal receiving chambers (101), and a peripheral portion (103) constituting an outer frame. Preferably, at least one of the partition walls (102) is formed as a thin portion that has a smaller thickness than the peripheral portion (103).

### TECHNICAL FIELD

The present invention relates to a connector.

### BACKGROUND

As a connector that has been used in recent years for a wire harness or the like of a vehicle such as an automobile, a connector is known which includes a housing that has a plurality of terminal receiving chambers for receiving terminals that are connected to end portions of wires (see Patent Document 1, for example). In recent years, connectors of this type have been made more and more compact, while the number of terminal receiving chambers has been increasing in accordance with the increase in the number of wires. Thermoplastic resins, such as polybutylene terephthalate and polyamide, are widely used as the materials for the housing.

### PRIOR ART DOCUMENT

### Patent Document

Patent Document 1: JP 2002-008787A

### SUMMARY OF THE INVENTION

### Problems to be Solved

However, as size reduction and multipolarization of connectors have been advanced, locally thin portions, such as partition walls between adjacent terminal receiving chambers, have come to be found in a housing. If a housing has a locally thin portion, the mold cannot be completely filled with the molten resin during injection molding, and thus molding defects caused by blockage of the resin are likely to occur. If such a molding defect occurs, correcting the mold will require much time and expenditure. Moreover, with respect to the production of a mold as well, it is necessary to enlarge a resin flow path through which the molten resin flows, and this imposes limitations on the shape of the housing. Furthermore, if a thermoplastic resin that exhibits favorable flowability during injection molding is used in order to prevent molding defects, heat resistance decreases, and thus, it is difficult to retain the shape of the housing.

The present invention was made in view of the above-described background, and an object thereof is to provide a connector with which it is unlikely that a molding defect will occur during injection molding, and with which it is possible to retain the shape of a housing.

### Means to Solve the Problem

An aspect of the present invention is a connector having a housing that is formed of a cured product of a thermosetting liquid silicone.

### Effect of the Invention

The thermosetting liquid silicone is a liquid and therefore exhibits favorable flowability during injection molding of the housing. Thus, with the above-described connector, the mold can be completely filled with the thermosetting liquid silicone during injection molding, and it is thus possible to suppress molding defects caused by blockage of the material of the housing. Moreover, since the above-described connector has the housing formed of a cured product of the thermosetting liquid silicone, it is easy to ensure hardness, and it is thus possible to retain the shape of the housing.

### BRIEF DESCRIPTION OF THE DRAWINGS

FIG. 1 is an explanatory diagram schematically showing a housing of a connector of Embodiment 1 when viewed from a wire insertion side.

### DETAILED DESCRIPTION TO EXECUTE THE INVENTION

The above-described connector has a housing that is formed of a cured product of a thermosetting liquid silicone. The cured product can have a Vickers hardness (Hv) of 650 or greater. With this configuration, it is easy to ensure that the shape of the housing is retained. The Vickers hardness can be preferably 660 or greater, more preferably 670 or greater, and even more preferably 680 or greater. In light of the improvement in productivity that can be achieved by reducing the curing time, the easy availability of materials, and the like, the Vickers hardness can be, for example, 1,900 or less. Note that the Vickers hardness is a value that is measured in conformity with JIS Z 2244.

In the above-described connector, specifically, the housing may have one terminal receiving chamber, or may have a plurality of terminal receiving chambers, as a plurality of terminal receiving chambers for receiving terminals that are connected to end portions of wires. More specifically, the housing can be configured to have a plurality of terminal receiving chambers for receiving terminals that are connected to end portions of wires, partition walls between adjacent ones of the terminal receiving chambers, and a peripheral portion constituting an outer frame. Moreover, in this housing, at least one of the partition walls can be formed as a thin portion that has a smaller thickness than the peripheral portion. With this configuration, it is possible to reduce the size of the connector by reducing the size of the housing while keeping the strength of the housing. Note that, specifically, the terminal receiving chambers can be arranged in at least one direction of the horizontal direction and the vertical direction of the housing when viewed from a wire insertion side.

Specifically, the thickness of the thin portion can be 0.5 mm or less. In the case where a housing having a thin portion with a thickness of 0.5 mm or less is molded through injection molding of a molten thermoplastic resin, the mold cannot be completely filled with the molten resin, and thus, a molding defect caused by blockage of the resin is likely to occur. In contrast, in the above-described connector, a thermosetting liquid silicone is used as the material of the housing. Therefore, with the above-described connector, during molding of the housing having a thin portion with a thickness of 0.5 mm or less, a molding defect caused by blockage of the material of the housing is unlikely to occur. Thus, with the above-described configuration, it is possible to achieve a size reduction and multipolarization. Moreover, the time and the expenditure needed to correct the mold so as to eliminate a molding defect can be suppressed, and thus, a connector with excellent productivity can be obtained.

In light of enhancing the above-described effects, the thickness of the thin portion can be preferably 0.4 mm or less, and more preferably 0.3 mm or less. Note that the thickness of the thin portion can be, for example, 0.1 mm or greater, in light of the strength of the housing, ensuring the electrical insulation between the terminals, and the like.

In the above-described connector, the partition walls can be configured so as to include the thinnest portion, which is a portion of the housing that has the smallest thickness. With this configuration, it is easy to reduce the size of the connector by reducing the thickness of the partition walls.

In the above-described connector, specifically, the number of poles, which is the number of terminal receiving chambers, can be, for example, 1 to 153, and preferably 2 to 153.

The above-described connector can be configured such that, specifically, the thermosetting liquid silicone is composed of a mixture of a first silicone component and a second silicone component, the first silicone component containing a vinyl group, and the second silicone component containing a hydroxy group. With this configuration, a connector including a housing that has a Vickers hardness within the above-described range is easily obtained by curing the mixture through heating.

The above-described connector has the housing formed of a cured product of the thermosetting liquid silicone, and thus can exhibit high heat-resistance. Therefore, the above-described connector can be suitably used in locations exposed to a high-temperature environment, such as a location around an engine of an automobile or a location around a battery thereof, for example.

Note that the above-described configurations can be combined as desired, if necessary in order to achieve the above-described effects and the like, or for other purposes.

### EMBODIMENTS

### Embodiment 1

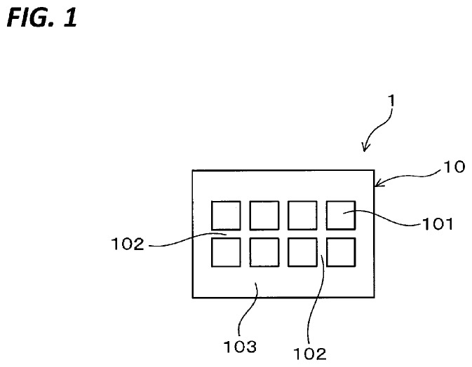

A connector of Embodiment 1 will be described using FIG. 1. As shown in FIG. 1, a connector 1 of the present embodiment has a housing 10. The housing 10 has a plurality of terminal receiving chambers 101 for receiving terminals that are connected to end portions of wires. In FIG. 1, the plurality of terminal receiving chambers 101 are connected in both the horizontal direction and the vertical direction, and in each of the horizontal direction and the vertical direction, the terminal receiving chambers 101 are arranged at regular intervals. Moreover, the housing 10 has partition walls 102 between the terminal receiving chambers 101. Moreover, the housing 10 has a peripheral portion 103 that constitutes a housing outer frame. The peripheral portion 103 surrounds the terminal receiving chambers 101 and the partition walls 102. In the present embodiment, the partition walls 102 are formed as thin portions that have a smaller thickness than the peripheral portion 103. Note that, in the present embodiment, the above-described wires are wires included in a wire harness (not shown) in which a plurality of wires are bound together. Moreover, the terminals that are connected to the end portions of the wires are female terminals. The connector 1 is configured to be engageable with a mating connector (not shown) provided in an electrical device or the like. The mating connector has the same number of mating terminals as the terminals that are to be received in the terminal receiving chambers 101. The mating terminals are male terminals.

In the connector 1, the housing 10 is formed of a cured product of a thermosetting liquid silicone. Specifically, the housing 10 is formed, with use of an injection molding method, by a thermosetting liquid silicone injected into a mold being cured through heating. In the present embodiment, the cured product has a Vickers hardness of 650 or greater. The above-described partition walls 102 have a thickness of 0.5 mm or less.

The thermosetting liquid silicone is a liquid, and therefore exhibits favorable flowability during injection molding of the housing 10. Thus, with the connector 1 of the present embodiment, the mold can be completely filled with the thermosetting liquid silicone during injection molding of the housing 10, and it is possible to suppress molding defects caused by blockage of the material of the housing. Moreover, since the connector 1 of the present embodiment has the housing 10 formed of a cured product of the thermosetting liquid silicone, it is easy to ensure hardness, and it is thus possible to retain the shape of the housing.

### EXPERIMENTAL EXAMPLES

Hereinafter, the connector having the above-described housing will be described in greater detail using experimental examples.

Preparation of Materials

A thermosetting liquid silicone rubber (“LSR7090” manufactured by Momentive Performance Materials Japan LLC) was prepared as a thermosetting liquid silicone (1). Also, a thermosetting liquid silicone rubber (“LSR7080” manufactured by Momentive Performance Materials Japan LLC) was prepared as a thermosetting liquid silicone (2). Note that both LSR7090 and LSR7080 are composed of two components, a component A and a component B, the component A containing a vinyl group, and the component B containing a hydroxy group.

Also, polybutylene terephthalate (PBT) and polyamide (PA), which are thermoplastic resins, were prepared for comparison.

Production of Housing Samples

The component A and the component B of LSR7090 serving as the thermosetting liquid silicone (1) were mixed at ratio of 1:1, and the obtained mixture was injected into a mold and cured through heating with use of an injection molding machine at a cylinder temperature and a mold temperature shown in Table 1. After that, the cured product was cooled and released from the mold, and thus, a housing of Sample 1 was obtained. Note that the number of poles of the housing of Sample 1 was 50, and the thickness of the partition walls between the terminal receiving chambers thereof was 0.3 mm.

A housing of Sample 2 was obtained in a similar manner to that of Sample 1, except that the component A and the component B of LSR7080 serving as the thermosetting liquid silicone (2) were mixed at a ratio of 1:1, and the obtained mixture was used.

A connector of Sample 1C was obtained in a similar manner to that of Sample 1, except that polybutylene terephthalate was used instead of the thermosetting liquid silicone and injected into a mold at a cylinder temperature and a mold temperature shown in Table 1. Moreover, a housing of Sample 2C was obtained in a similar manner to that of Sample 1, except that polyamide was used instead of the thermosetting liquid silicone and injected into a mold at a cylinder temperature and a mold temperature shown in Table 1.

Vickers Hardness

The Vickers hardness of each sample was measured in conformity with JIS Z 2244. The measurement was performed five times for each sample, and an average value of the obtained measurement values was used as the Vickers hardness of that sample. Note that Samples 1C and 2C were made of the thermoplastic resins, and therefore, the measurement of the Vickers hardness thereof was difficult. For this reason, with respect to Samples 1C and 2C, the Rockwell hardness (HRC) was measured in conformity with JIS Z 2245.

Moldability

The partition walls between the terminal receiving chambers of the housing of each injection-molded sample were observed, and if blockage (hesitation) of the molding material was not observed, and a short shot did not occur, the sample was evaluated as “A”, whereas if blockage (hesitation) of the molding material was observed, and a short shot occurred, the sample was evaluated as “C”.

Table 1 collectively shows the molding conditions, the measurement results, and the evaluation results.

TABLE 1

| | | Sample | Sample | Sample | Sample |
|---|---|---|---|---|---|
| | | 1 | 2 | 1C | 2C |
| Material of | Thermosetting | ● | — | — | — |
| housing | liquid silicone (1) | | | | |
| | Thermosetting | — | ● | — | — |
| | liquid silicone (2) | | | | |
| | PBT | — | — | ● | — |
| | PA | — | — | — | ● |

| | | | | |
|---|---|---|---|---|
| Cylinder temperature (° C.) | 25 | 25 | 250 | 320 |
| Mold temperature (° C.) | 180 | 180 | 80 | 150 |
| Vickers hardness (Hv) | 940 | 680 | — | — |
| Rockwell hardness (HRC) | — | — | 64.7 | 59.2 |
| Absence/presence of molding | Absent | Absent | Present | Present |
| defect | | | | |

(*) “●” means that the material in the left-hand column was used.

The following can be seen from Table 1. The housings of Samples 1C and 2C used the thermoplastic resins, PBT and PA. Therefore, a molding defect caused by blockage of the resin was observed.

In contrast, the housings of Samples 1 and 2 used the thermosetting liquid silicones, which are liquids exhibiting favorable flowability during injection molding of the housings. Therefore, during injection molding of the housings of Samples 1 and 2, the mold was completely filled with the thermosetting liquid silicone, and molding defects caused by blockage of the material of the housing were suppressed. Moreover, the housings of Samples 1 and 2 had a Vickers hardness of 650 or greater, and thus, it was confirmed that each housing had a hardness that can satisfactorily retain the shape of the housing.

An embodiment of the present invention has been described in detail above, but the present invention is not limited to the foregoing embodiment and experimental examples, and various changes can be made thereto without departing from the gist of the present invention.

1. A connector comprising a housing that is formed of a cured product of a thermosetting liquid silicone.

2. The connector according to claim 1, wherein the cured product has a Vickers hardness of 650 or greater.

3. The connector according to claim 1,
wherein the housing has:
a plurality of terminal receiving chambers for receiving terminals that are connected to end portions of wires;
partition walls between adjacent ones of the terminal receiving chambers; and
a peripheral portion constituting an outer frame, and
at least one of the partition walls is formed as a thin portion that has a smaller thickness than the peripheral portion.

4. The connector according to claim 3, wherein the thickness of the thin portion is 0.5 mm or less.

5. The connector according to claim 1,
wherein the thermosetting liquid silicone is composed of a mixture of a first silicone component and a second silicone component,
the first silicone component containing a vinyl group, and the second silicone component containing a hydroxy group.
